(19) United States
(12) Patent Application Publication
(10) Pub. No.: US 2013/0113268 A1
(43) Pub. Date: May 9, 2013

(54) RIM FLANGE TRIM RING REPAIR SYSTEM

(71) Applicant: Zvonko Dimovski, Sterling Heights, MI (US)

(72) Inventor: Zvonko Dimovski, Sterling Heights, MI (US)

(73) Assignee: FORD GLOBAL TECHNOLOGIES, LLC, DEARBORN, MI (US)

(21) Appl. No.: 13/292,107

(22) Filed: Nov. 9, 2011

(51) Int. Cl. B60B 7/01; B23P 6/00; B32B 43/00

(52) U.S. Cl. 301/37.24; 156/94; 29/402.01

(57) ABSTRACT

A rim flange trim ring adapted to be attached to a rim flange adapted to support a tire, the rim including a cylindrical body portion including a first end and a second end, the first and second ends each terminating in a radially outward extending rim. The rim flange trim ring includes a generally annular body having a U-shaped cross-section, and the rim flange trim ring is adapted to be placed on and to receive the rim flange.

### TECHNICAL FIELD

This disclosure relates to a rim of a vehicle wheel and tire assembly, and, more specifically, to devices and methods for repairing a wheel's rim flanges.

### BACKGROUND

A wheel and tire assembly includes a wheel or rim, and a tire that is supported on the rim. A rim flange is the part of the wheel that supports the tire bead in a lateral direction. Usually, wheels and rim flanges for vehicles such as bicycles, cars, or trucks are made of steel, aluminum, or other metal. In some instances, bright rims are used, which are rims of a light, bright color. Although attractive and decorative, bright wheels can readily show damage or corrosion on the rim flanges.

Moisture and oxygen in surrounding air can exert a corrosive effect on the rim. Vibration of the tire and the elevated temperature due to the vibrations make the environment even more severe such that the corrosion on the rim is accelerated. Further, the tire that is mounted on the rim is often made of vulcanized rubber containing sulfur-based compounds. The sulfur-containing compounds within the tire can generate a corrosive environment, which can further contribute to rim corrosion. In addition, the moving wheel assembly can get into contact with moisture on the ground (and air), which further contributes to the corrosion process.

Currently, rim corrosion or damage is remedied by replacing with a new wheel. In order to replace the wheel, a qualified technician will generally first hoist the vehicle, remove the wheel and tire assembly from the vehicle, dismount the tire, remove a tire pressure monitoring sensor if applicable, acquire a new wheel, install a new tire valve, install the tire pressure monitoring sensor if applicable, mount the tire, balance the wheel and tire assembly, and install the wheel and tire assembly back onto the vehicle.

Replacing the wheel in this fashion involves tedious and time-consuming tasks. And even if only a small portion of the rim flange is corroded, the complete rim replacement increases costs and rim material waste.

Therefore, there is a need for devices, systems, and methods that can repair the rim flange without a need to replace the entire wheel.

### SUMMARY

The present disclosure discloses a rim flange trim ring adapted to be attached to a wheel's rim. The rim flange trim ring includes a generally annular body having a U-shaped cross-section, and the rim flange trim ring is adapted to be placed on and to receive the rim flange.

In some embodiments, the vehicle wheel assembly further includes a sealant or adhesive applied to the rim flange trim ring such that the sealant or adhesive is in contact with the flange. In some embodiments, the sealant or adhesive is silicone.

In some embodiments, the circumference of the rim flange trim ring may include a radial seam.

In some embodiments, the U-shaped rim flange trim ring may include a locking mechanism to secure the U-shaped rim flange trim ring to the rim flange. The locking mechanism can include at least one seam, barb, or at least one dimple or depression, at the outer, or inner, diameter of the rim flange trim ring. The locking mechanism can also include at least one seam in the lateral direction at the outer, or inner, diameter of the rim flange trim ring.

The present disclosure also discloses a method for repairing an aesthetically unacceptable appearance of a rim flange of a wheel. The method includes placing a substantially ring shaped rim flange trim ring having a substantially U-shaped cross-section on at least a portion of the rim flange.

In some embodiments, the method further includes cleaning, sanding scraping, or scuffing the flange.

In some embodiments, the method further includes applying a sealant or adhesive to the rim flange trim ring such that the sealant or adhesive is in contact with the rim flange. The sealant or adhesive can be a bead of silicone in some embodiments.

In some embodiments, the rim flange trim ring is provided as a single circular ring without a seam. In other embodiments, the rim flange trim ring is provided with a seam.

### BRIEF DESCRIPTION OF THE FIGURES

The disclosure and the following detailed description of certain embodiments thereof may be understood with reference to the following figures:

FIG. 1 is a perspective view of a vehicle wheel and tire assembly in accordance with the present disclosure, illustrating a portion of a rim flange trim ring placed on a rim flange.

FIG. 2 is an exploded perspective view of the vehicle wheel assembly of FIG.

FIG. 3 is a cross sectional view of a rim flange and rim flange trim ring, in accordance with an embodiment of the present disclosure.

FIG. 4 is a cross sectional view of optional constructions of rim flange trim ring.

### DETAILED DESCRIPTION

Persons of ordinary skill in the art will appreciate that the following description of the present disclosure is illustrative and not limiting in any way. Other embodiments of the disclosure will readily be suggested to those skilled in the art. It shall be appreciated by those of ordinary skill in the art that the apparatus/device described hereinafter may vary as to configuration and as to details. In addition, the methods disclosed hereafter may also vary as to details, order of the steps, or other variations without departing from the spirit and scope of the present disclosure.

In general, this disclosure is directed to methods and devices for repairing a rim flange of a vehicle wheel assembly. The disclosed methods and devices provide an aesthetically acceptable appearance to a rim flange that is aesthetically unacceptable due to presence of corrosion on at least some portion of the rim flange.

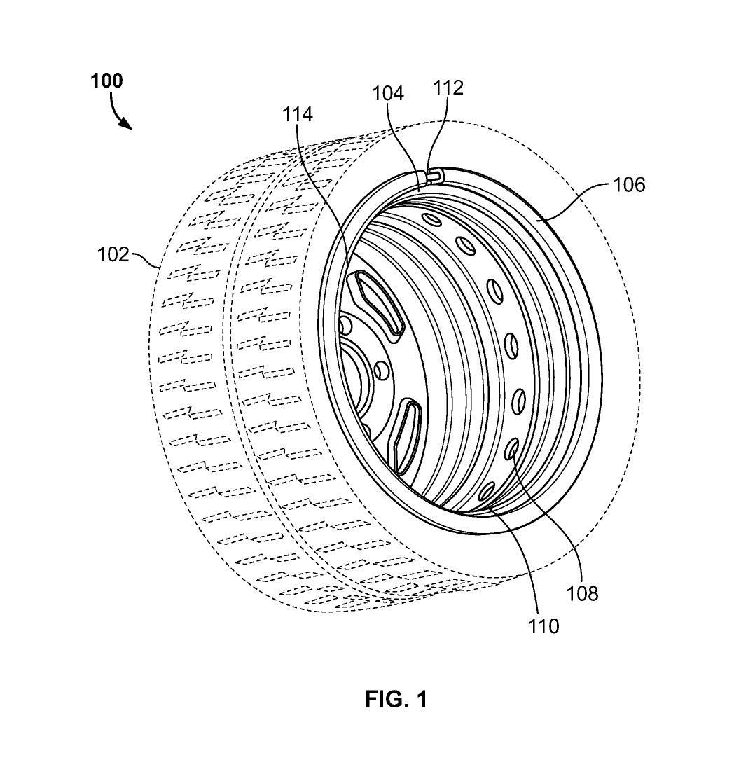

FIG. 1 is a perspective view of a vehicle wheel and tire assembly 100, in accordance with an embodiment of the present disclosure. The vehicle wheel and tire assembly 100 includes a tire 102, a wheel 104, and a rim flange trim ring 106.

As is commonly known by a person ordinarily skilled in the art, the tire 102 is a ring shaped member that is configured to provide a flexible cushion to the vehicle wheel assembly 100 and keep it in contact with the ground. The tire 102 can be made of synthetic rubber, natural rubber, fabric, wood, metal, and several other materials including various types of chemicals without limitations. The tire 102 may also include metal wires that are configured to resist wear and tear of the tire 102. It must be appreciated by a person ordinarily skilled in the art that various types of tires as are conventionally used or sold in the market can be employed for the purposes of the present disclosure.

The wheel 104 is configured to support the tire 102 circumferentially such that an outer surface of the tire 102 is on an inner surface of the rim flanges of the wheel 104. The wheel 104 has a flat and substantially ring shaped structure designed preferably to facilitate support of the tire. The wheel 104 includes a base portion 108, which provides support to the tire 102 such that the tire 102 is held firmly on the base portion 108. In some embodiments, the tire 102 is held on the wheel 104 by an internal tire force exerted by an air pressure of the tire 102.

The wheel 104 further includes the rim flange 112 extending radially outward from the base portion 108. The rim flange 112 of the wheel 104 extends along the complete rim circumference. The rim flange 112 has an outer surface facing outward from a center of the vehicle wheel assembly 100, and an inner surface facing inward toward the center of the vehicle wheel assembly 100.

As discussed above, the vehicle wheel assembly 100 further includes the rim flange trim ring 106. The rim flange trim ring 106 is a substantially annular body having a U-shaped cross-section configured to be mounted on and cover at least a portion of the flange 112 of the wheel 104. FIG. 1 shows a perspective view, in accordance with an embodiment of the present disclosure, of the vehicle wheel assembly 100, with a portion of the rim flange trim ring 106 removed in order to illustrate the flange trim ring 106 on the rim flange 112. As discussed below, the rim flange trim ring 106, in the preferred embodiment, is intended to cover the entire rim flange 112. In other less preferred embodiments (not shown), only a portion of the rim flange 112 may be covered by the flange trim ring 106.

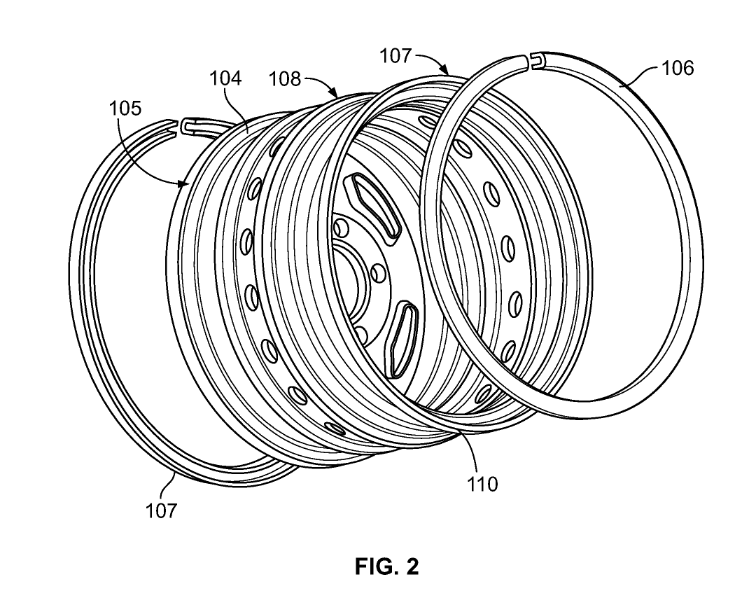

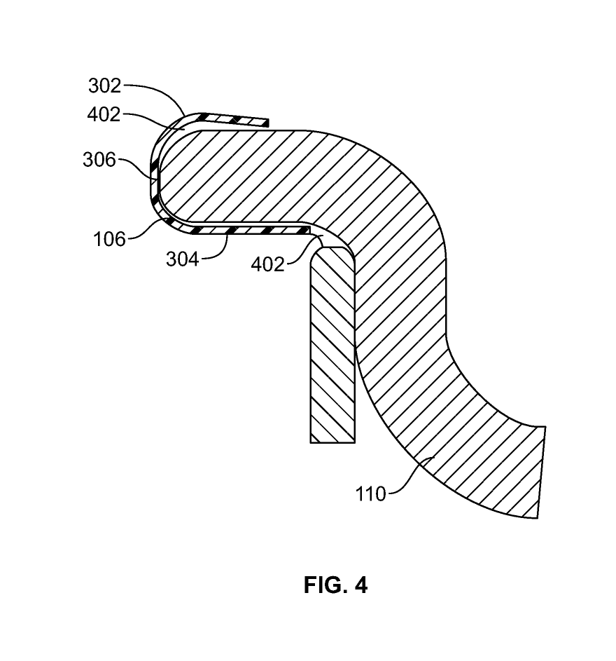

FIG. 2, an exploded perspective view of FIG. 1. Referring now to FIGS. 1, 2, 3, and 4, the rim flange trim ring 106 is described in greater detail. The rim flange trim ring 106 is substantially an annular body having a U-shaped cross-section having a first wall portion 302 and a second wall portion 304 and an adjoining portion 306 extending from and joining the first wall portion 302 and the second wall portion 304. The first wall portion 302, the second wall portion 304, and the adjoining portion 306 form an integral part of the same rim flange trim ring 106. The rim flange trim ring 106 has a U-shaped cross section. The rim flange trim ring 106 is configured to be mounted on and cover at least a portion of the rim flange 112 of the wheel 104.

In accordance with various embodiments of the present disclosure, the first wall portion 302 of the rim flange trim ring 106 is configured to fit onto the outer surface of the rim flange 112, and the second wall portion 304 of the rim flange trim ring 106 is configured to fit onto the inner surface of the rim flange 112, such that at least a portion of the rim flange 112 is covered by the rim flange trim ring 106.

In accordance with an embodiment, the rim flange trim ring 106 may be manufactured and formed, stamped or extruded from a metal sheet constituting the material desired for the rim flange trim ring 106, such that the appearance of the flange cover appears to match the appearance of the wheel 104. Or it may intentionally be mismatched in color and brightness in order to enhance the wheel aesthetically.

In accordance with an embodiment, the rim flange trim ring 106 may be manufactured by injection molding or extrusion from plastic constituting the material desired for the rim flange trim ring 106, such that the appearance of the flange cover appears to match the appearance of the wheel 104. Or it may intentionally be mismatched in color and brightness in order to enhance the wheel aesthetically.

A locking design feature may be manufactured to facilitate locking of the rim flange trim ring 106 to the rim flange 112. In some embodiments, the locking design feature may include at least one seam, barb, dimple or depression (referred to as a first barb 308) at an inner, or outer, diameter of the rim flange trim ring 106. In accordance with various other embodiments, another locking feature may be employed for locking the rim flange trim ring 106 onto the rim flange 112. Further, various conventionally used locking or snap fitting features may be employed. In some embodiments, the rim flange trim ring 106 is a single segment having a first end and a second end. In other embodiments, the rim flange trim ring 106 may comprises of a contiguous, circumferential ring of material.

The rim flange trim ring 106 is manufactured in a form such that the rim flange trim ring 106 is a single complete ring without a seam. When a complete ring is used, the rim flange trim ring 106 may be made of a metalic material, or a plastic material, so that the rim flange trim ring 106 can be press-fit into position on the rim flange 112.

In accordance with an embodiment of the present disclosure, the vehicle wheel assembly 100 further comprising a sealant or adhesive 402 applied to the rim flange trim ring 106, such that the sealant 402 is in contact with the rim flange 112. In an embodiment, the sealant or adhesive 402 includes a bead of silicone. In accordance with several other embodiments, various other types of sealants or adhesives can be utilized without limiting the spirit and scope of the present disclosure. In various embodiments, the sealant or adhesive 402 can be applied as an adhesive, spray, coating, thin film, bead, and the like. The sealant 402 is configured to protect the flange surface from the main causes of corrosion or rusting, such as moisture, air, salt, and the like. It must be appreciated by a person ordinarily skilled in the art that the sealant or adhesive 402 can be disposed at either or one of the sides in accordance with some alternative embodiments of the present disclosure.

The method for repairing an aesthetically unacceptable appearance of the rim flange 112 of a vehicle includes placing the rim flange trim ring 106 having a substantially u-shaped cross-section on at least a portion of the rim flange 112. The rim flange trim ring 106 can be custom designed so it can be placed on a rim flange 112 of various sizes. Further, the rim flange trim ring 106 can be customized for different vehicle wheel assemblies such as for a bicycle, bike, motorcycle, car, truck, RV, and the like.

The method further includes securing the rim flange trim ring 106 on at least a portion of the rim flange 112. In accordance with some embodiments, the rim flange trim ring 106 can be fixed with the use of a dead-blow hammer or a rubber mallet, as are conventionally available. In some embodiments, the mallet or hammer is made of a rubber or any other similar material that is configured to push the rim flange trim ring 106 onto the rim flange 112 hard enough to secure it firmly without causing any damage, such as scratch, to the rim flange trim ring 106 or the rim flange 112.

In some embodiments, the method may also include cleaning, sanding, scraping, or scuffing the rim flange 112. The process of cleaning, sanding, scraping, or scuffing is done to remove corrosion, or excess paint and wheel material present on the rim flange 112 or a portion of the rim flange 112. The process of cleaning, sanding, scraping, or scuffing is performed prior to placing of the rim flange trim ring 106 onto the rim flange 112. In some embodiments, cleaning, sanding, scraping, or scuffing can be done using a cleaning or sanding pad, or sandpaper of any desired type as is conventionally available.

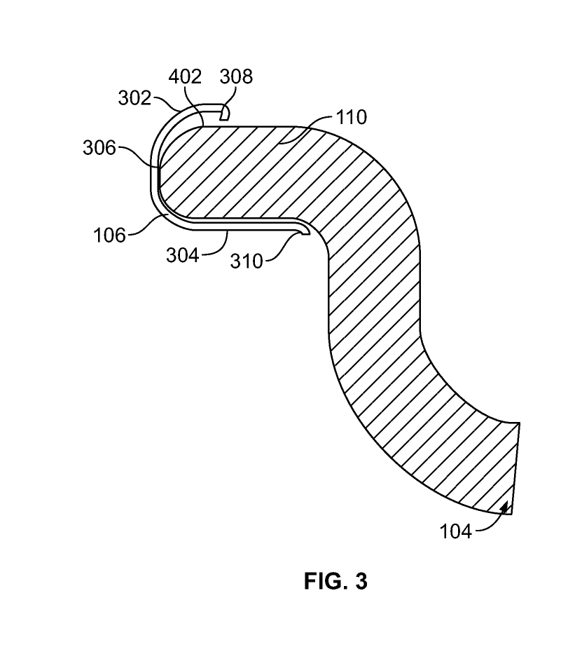

In some embodiments, the method may also include applying a sealant or adhesive, such as the sealant or adhesive 402 as discussed in conjunction with FIG. 3, to the rim flange or rim flange trim ring such that the sealant or adhesive 402 is in contact with the flange 112. In an embodiment, the sealant or adhesive 402 includes a bead of silicone. In accordance with several other embodiments, various other types of sealants or adhesives can be utilized without limiting the spirit and scope of the present disclosure. In various embodiments, the sealant or adhesive 402 can be applied as an adhesive, spray, coating, thin film, bead, and the like. The sealant or adhesive 402 is configured to protect the flange surface from main causes of corrosion or rusting such as moisture, air, salt, and the like.

In some embodiments, the method further includes locking the rim flange trim ring 106 onto the rim flange 112 at least one of its end portions. The step of locking can be performed through a locking feature provided to facilitate locking of the rim flange trim ring 106 to the rim flange 112. In some embodiments, the locking feature may include at least one seam, barb, dimple or depression (referred to as the first barb 308) at the inner or outer diameter of the rim flange trim ring 106 and/or at least one seam, barb, dimple or depression (referred to as the second barb 310) at the outer or inner diameter of the rim flange trim ring 106. In accordance with various other embodiments (not shown), an indentation, a protrusion, or any other locking feature may be employed for locking the rim flange trim ring 106 onto the rim flange 112. Further, various conventionally locking, press-fitting or snap fitting features may be employed.

It must be understood that the foregoing description is suited for various types of vehicle wheel assemblies that are available in the market conventionally or will be available in the market in future. Further, the foregoing description is suited for various types of vehicles such as bicycles, cars, motorcycles, aircrafts, trucks, cargo buses, or any other types of wheeled or railed devices.

As is discussed in detail above, an advantage of the present disclosure is that it provides methods and devices to repair the vehicle wheel assembly, the rim flange, a portion of the wheel without replacing the wheel, or the portion of wheel completely.

Another advantage of the present disclosure is that it provides methods and devices to repair the vehicle wheel assembly, the rim flange, or a portion of the wheel in a timely manner and cost effectively.

It is to be understood that the foregoing description is a detailed description of the illustrative embodiments only. The scope of the claims is not limited to these specific embodiments. Various elements, details, execution of methods, and uses can differ from those described above. The scope of the disclosure is determined by the following claims and their legal equivalents.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but it is to be understood in the broadest sense allowable by law.

What is claimed is:

1. A rim flange trim ring adapted to be attached to a rim flange adapted to support a tire, the rim including a cylindrical body portion including a first end and a second end, the first and second ends each terminating in a radially outward extending rim, the rim flange trim ring comprising:
a generally annular body having a U-shaped cross-section, the rim flange trim ring being adapted to be placed on and to receive said rim flange.

2. The rim flange trim ring of claim 1, wherein said rim flange trim ring may comprise of a plurality of segments.

3. The rim flange trim ring of claim 1, wherein the rim flange trim ring comprises a single annular ring.

4. The rim flange trim ring of claim 1, wherein the rim flange trim ring further includes means for securing said rim trim ring to said rim flange.

5. The rim flange trim ring of claim 4, wherein the securing means includes at least one seam, barb, dimple or depression at an inner or outer diameter of the rim flange trim ring.

6. A method for repairing an aesthetically unacceptable appearance of a rim flange, the method comprising:
placing a rim flange trim ring on a rim flange, the rim flange trim ring comprising:
a generally annular body having a U-shaped cross-section, said rim flange cover being adapted to be placed on and to receive said rim flange.

7. The method of claim 6 further comprises securing the rim flange trim ring on at least a portion of the rim flange.

8. The method of claim 6 further comprising cleaning, sanding, scraping, or scuffing the rim flange.

9. The method of claim 6 further comprising applying a sealant or adhesive to the rim flange.

10. The method of claim 9, wherein the sealant or adhesive is a bead of silicone.

11. The method of claim 6, wherein the rim flange trim ring is provided as a single annular ring.
